(19) United States
(12) Patent Application Publication
(10) Pub. No.: US 2016/0114317 A1
(43) Pub. Date: Apr. 28, 2016

(54) DEVICE AND SYSTEM FOR SAMPLING AND ANALYZING A LIQUID SPECIMEN

(71) Applicant: Moishe Bodner, Brooklyn, NY (US)

(72) Inventor: John Ennis, Vancouver, WA (US)

(21) Appl. No.: 14/524,666

(22) Filed: Oct. 27, 2014

(51) Int. Cl. B01L 3/00

(52) U.S. Cl. CPC B01L 3/5023; B01L 3/5027; B01L 2400/0406; B01L 2300/069; B01L 2300/0838; B01L 2300/12; B01L 2300/161; B01L 2300/0672

(57) ABSTRACT

A system for sampling and analyzing a liquid specimen includes a device and a reagent container that can be pre-filled with an analytical reagent. The device may have a sample collecting system for collecting a predetermined volume of the liquid specimen, and a container for analyzing the liquid specimen collected by the sample collecting system. The sample collection system includes a sorptive porous member. The sample collection system may further include a capillary channel in direct fluid communication with the sorptive member. The sample collecting system of the device is capable of collecting a predetermined volume of the liquid specimen which is greater than 4 microliters and which can range up to about 80 microliters.

### FIELD

The present disclosure relates to diagnostic testing of liquid specimens. More particularly, the present disclosure relates to a device for sampling and analyzing liquid specimens, wherein the device is capable of collecting more than 4 microliters of the liquid specimen. The present disclosure further relates to a system or kit for sampling and analyzing liquid specimens that comprise the device.

### BACKGROUND

Body fluids have long been used to diagnostically test and monitor for various biochemical and/or physiological conditions of a person's body. Typically, blood and urine samples are used to analyze and determine various conditions of the body.

In the past, the analysis of body fluids was usually performed in laboratories. More recently, however, devices and systems have been developed for sampling and analyzing liquid specimens in the field by non-trained personnel. These devices and systems automatically sample, process, and analyze liquid specimens and deliver the result visually.

Many of these devices and systems utilize a capillary channel to collect a predetermined volume of the liquid specimen to analyze. The capillary channel of typical devices and systems, however, have difficulty collecting sample volumes which exceed 4 microliters. This can be problematic because the smaller the sample volume, the lower amount of total target analyte that is available. As the total specimen volume drops, the total amount of analyte gets progressively closer to the limit of detection defined by the test methodology.

Accordingly, a liquid specimen sampling and analyzing device, system, and kit are needed that are capable of accurately collecting sample volumes which each exceed 4 microliters.

### SUMMARY

Disclosed herein is a device for sampling and analyzing a liquid specimen. In various embodiments, the device may comprise: a sample collecting system for collecting a predetermined volume of the liquid specimen; and a container for analyzing the liquid specimen collected by the sample collecting system; wherein the sample collection system comprises a sorptive member.

In some embodiments, the sample collecting system may further comprise a capillary channel having an inlet opening and an outlet opening, wherein the sorptive member is disposed at the outlet opening of the capillary channel in direct fluid communication therewith.

In some embodiments, the container may include a sample collecting section, and wherein the sample collecting section of the container may include the sorptive member.

In some embodiments, the sample collecting section of the container may further include the capillary channel of the sample collecting system.

In some embodiments, an outer surface of the sample collecting section may have an extended portion, and wherein the capillary channel of the sample collecting system extends though the extended portion.

In some embodiments, the outer surface of the sample collecting section may have a tapered portion.

In some embodiments, the device may further comprise a sample analyzer for analyzing the liquid specimen collected by the sample collection system, wherein the sample analyzer is disposed in the container.

In some embodiments, the container may further include a chamber for holding the sample analyzer.

In some embodiments, the sample analyzer may comprise a test strip.

In some embodiments, the device may further comprise a carrier for holding the sorptive member.

In some embodiments, the carrier holds the sample analyzer.

In some embodiments, the carrier is disposed within the container.

In some embodiments, the carrier may include first and second ends, the sorptive member disposed at one of the first and second ends of the carrier.

In some embodiments, the sorptive member may comprise sintered polymeric material, a cellulosic material, an injectable porous polymeric material, a polypropylene material, a polyethylene material, a high density polyethylene material, ultra-high molecular weight polyethylene, a plurality of hydrophilic polyethylene sheath/polyester core (PE/PET) fibers, a plurality of hydrophilic polyester sheath/polyester core (PET/PET) fibers, any combination thereof.

In some embodiments, the sorptive member may have hydrophilic internal surfaces resulting from a surfactant.

In some embodiments, the predetermined volume of the liquid specimen comprises greater than 4 microliters.

In some embodiments, the predetermined volume of the liquid specimen comprises up to about 80 microliters.

In some embodiments, the liquid specimen may be collected in at least one of the capillary channel and the sorptive member.

In some embodiments, the liquid specimen may be collected in the capillary channel and the sorptive member.

In some embodiments, the liquid specimen may be collected in the sorptive member.

In some embodiments, the container may be a single unitary member.

In some embodiments, the container may further include first and second sections connected to one another, the first section may include at least one of the capillary channel and the sorptive member of the sample collecting system and the second section of the container may include the chamber.

Further disclosed herein is a system for sampling and analyzing a liquid specimen. In various embodiments, the system may comprise a reagent container and the device of any of the above described embodiments, the reagent container for containing an analytical testing reagent.

In some embodiments, the reagent container is the system may be pre-filled with the reagent.

In some embodiments, the reagent container of the system may include an open end closed by a frangible substrate.

In some embodiments, the extended portion of the container of the device of the system is for puncturing the frangible substrate.

In some embodiments, the tapered portion of the container of the device of the system is for engaging the open end of the reagent container in an air-tight manner.

### BRIEF DESCRIPTION OF THE DRAWINGS

FIG. 1 is a perspective view of an embodiment of a device of a system for sampling and analyzing liquid specimens.

FIG. 2A is a sectional elevational view of an embodiment of the sampling device of the system.

FIG. 2B is an enlarged sectional elevational view of a portion of a container of the sampling device of FIG. 2A.

FIG. 2C is a sectional view through line 2C-2C of FIG. 2B.

FIGS. 3A-3C illustrate the operation of the sampling and analyzing system where FIG. 3A is a sectional view of a portion of an embodiment of the sampling device of the system as it collects a liquid specimen, FIG. 3B is a perspective view of the sampling device of FIG. 3A and an embodiment reagent container of the system as the sampling device punctures a frangible substrate of the reagent container, and FIG. 3C is a sectional view of the sampling device of FIG. 3A and the reagent container which illustrates reagent transfer from the reagent container to the sampling device.

FIG. 4A is a sectional elevational view of another embodiment of the sampling device of the system.

FIG. 4B is an exploded cross-sectional elevational view of the sampling device of FIG. 4A.

FIG. 5A is an exploded perspective view of another embodiment of the sampling device of the system comprising a carrier for a sorptive member and a sampler analyzer of the sampling device.

FIG. 5B is an enlarged view of a portion of the carrier shown in FIG. 5A.

FIG. 6 is a sectional elevational view of another embodiment of the sampling device of the system.

### DETAILED DESCRIPTION

Disclosed herein is a kit or system for sampling and analyzing liquid specimens. The system is particularly useful for sampling and analyzing bodily fluids. The system may comprise a device for sampling a predetermined volume of a liquid specimen and performing the analysis thereon (sampling device) and a container for an analytical testing reagent (reagent container). The sampling device can be configured to collect a predetermined sample volume of liquid specimen which exceeds 4 microliters. For example, some embodiments of the sampling device may be configured to collect a predetermined sample volume of liquid specimen which comprises up to about 80 microliters. The sampling device can also be configured to collect a predetermined sample volume of liquid specimen which comprises 4 microliters or less.

The sampling device, in some embodiments, may use a capillary sample collecting system for collecting the predetermined sample volume of liquid specimen. In some embodiments, the sample collecting system comprises a capillary channel and a sorptive porous member (sorptive member). The capillary channel draws in and fills with an initial sample volume of the liquid specimen. When the capillary channel is filled with the initial sample volume of the liquid specimen, the sorptive member draws the initial sample volume of liquid specimen out of the capillary channel and holds it therein. As the sorptive member draws the initial sample volume of liquid specimen out of the capillary channel and holds it therein, the capillary channel draws and fills with an additional sample volume of liquid specimen until the sorptive member and the capillary channel are both filled with the liquid specimen, thereby allowing for a predetermined sample volume of the liquid specimen, that is greater than 4 microliters (e.g., up to about 80 microliters).

In some embodiments, the liquid specimen can be drawn into and held in the sorptive member by matrix sorptivity. In other embodiments, the matrix sorptivity of the sorptive member can be aided by treatment of sorptive member with a surfactant. In further embodiments, the matrix sorptivity of the sorptive member can be aided by performing a plasma treatment on the sorptive member. The plasma treatment can comprise without limitation a low temperature corona discharge plasma.

In various embodiments, the above mentioned sample volumes of liquid specimen can be achieved by strictly defining the physical properties/characteristics of the sorptive member (e.g., volume and porosity of the sorptive member) and positioning the sorptive member immediately adjacent to the capillary channel. By strictly specifying the physical properties/characteristics of the sorptive member of the sample collecting system and positioning it in direct fluid communication with the capillary channel, the sample volume collected by the sampling device can be tightly controlled.

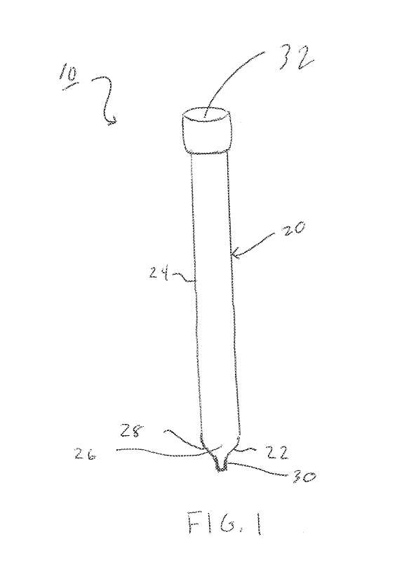

FIG. 1 illustrates an embodiment of the sampling device 10 of the liquid specimen sampling and analyzing system of the present disclosure. The sampling device 10 may comprise an elongated, unitarily formed container 20 having a sample collecting section 22 and a barrel section 24. The sample collecting section 22 may have an outer surface 26 formed by a frustonconical portion 28 and an extended sampling end portion 30, as shown in FIG. 1. The barrel section 24 may include an opening 32 at a free end thereof for accessing the interior of the barrel section 24. The sampling device container 20 may be made of a plastic material and be formed using plastic molding methods. In other embodiments, the sampling device container 20 can be made of a glass material, a metal or metallic material, or any other suitable material. The shape and size of the sampling device 10 including the shape and size of the sample collecting and barrel sections 22 and 24, respectively, of the container 20 may vary depending upon the liquid specimen to be sampled and analyzed.

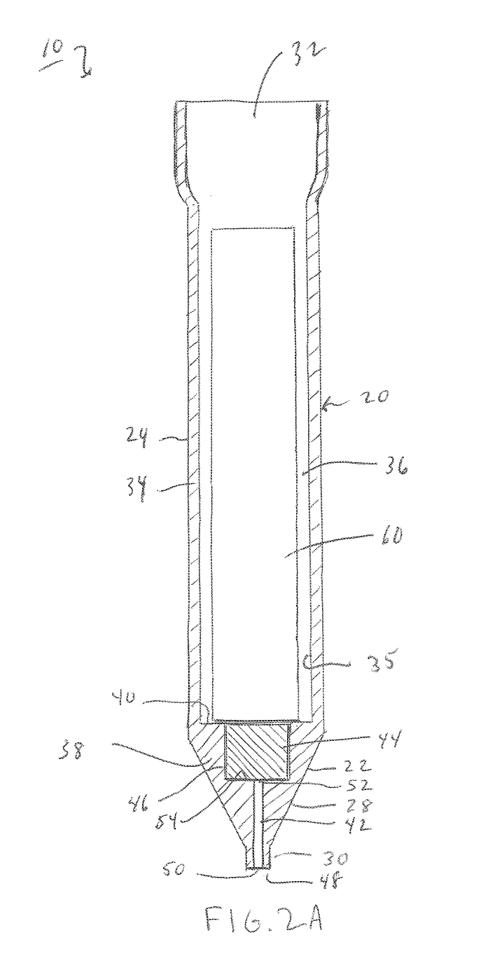

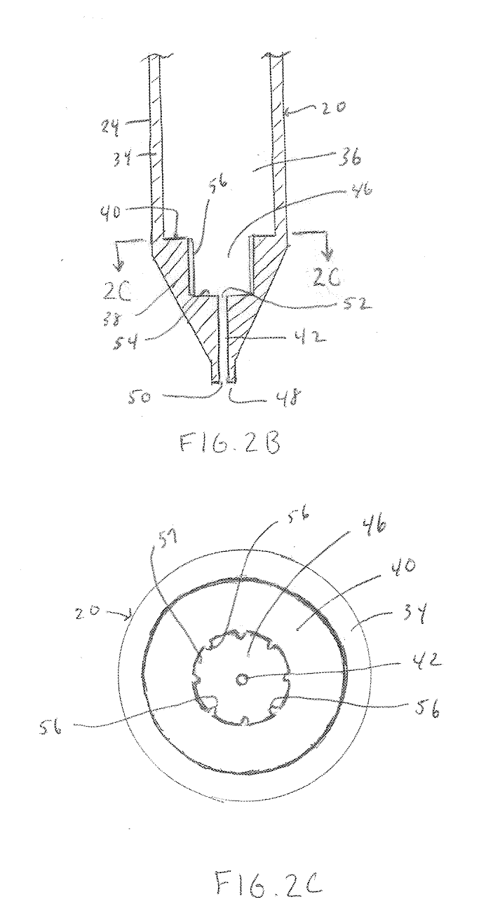

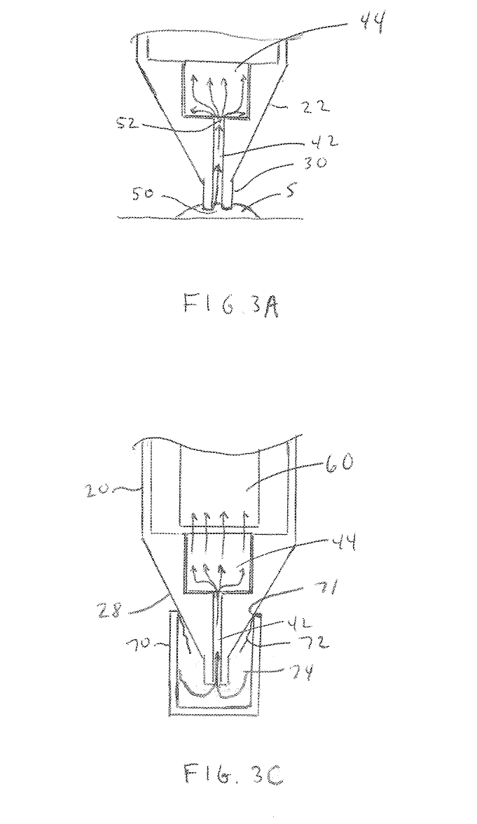

Referring collectively to FIGS. 2A and 2B, the barrel section 24 of the container 20 can comprise a cylindrical side wall 34 which defines an interior chamber 36 which is accessible via the opening 32 at the free end thereof. The sample collecting section 22 of the container 20 may comprise a solid body 38 having an interior surface 40 that forms a floor of the interior chamber 36 of the barrel section 24. The sample collecting section 22 of the container 20 includes the earlier described capillary sample collecting system, which comprises the capillary channel 42 and the sorptive member 44. The sample collecting system is operative for collecting a predetermined volume of a liquid specimen (greater than 4 microliters, e.g., up to about 80 microliters). A compartment 46 may be formed in the interior surface 40 of the sample collecting section solid body 38 for holding the sorptive member 44. The capillary channel 42 may extend between the compartment 46 and a sampling end 48 of the sample collecting section 22. The capillary channel 42 may have an inlet end 50 that communicates with the external environment and an outlet end 52 that communicates with the compartment 46. The sorptive member 44 is positioned against the bottom wall 54 of the compartment 46 so that it is directly adjacent to the outlet end 52 of the capillary channel 42, thereby allowing liquid specimen to be drawn out of the outlet end 52 of the channel 42 by the capillarity of the sorptive member 42. In the shown embodiment, one or more retaining ribs 56 may be provided on the sidewall 57 of the compartment 46 to prevent the sorptive member 44 from being forced away from the outlet end 52 of the capillary channel 42 due to hydrodynamic pressure of the constrained flow through the capillary system, which can cause the sorptive member 44 to move away from the outlet end 52 of the capillary channel 42. In addition or alternatively to the retaining ribs, a washer-like member or baffle member (not shown) can be provided over the sorptive member 44 and then secured to the inner surface 35 of the barrel section wall 34 to prevent the sorptive member 44 from being forced away from the outlet end 52 of the capillary channel 42. The washer-like member or baffle member can be secured to the inner surface 35 of the barrel section wall 35 by a press-fit arrangement, ultrasonic welding, adhesive bonding or any other suitable securing method.

Referring to still to FIG. 2A, the sampling device 10 may further comprise a sample analyzer 60 for analyzing the predetermined sample volume of the liquid specimen collected by the capillary sample collecting system. The sample analyzer may be disposed in the interior chamber 36 of the container barrel section 24. In some embodiments, the sample analyzer 60 may comprise a test strip which provides a visual indication of the result of the analysis. Such test strips are well known in the art and can include various reagents for performing the analysis on the liquid specimen. In other embodiments, the sample analyzer 60 can comprise a direct electrode system. In still other embodiments, the sample analyzer 60 can comprise a flow chip.

The shape, length, and diameter of the capillary channel can vary depending upon the liquid specimen to be sampled and analyzed. For example, some embodiments of the capillary channel can be straight, have a length of about 1.0 mm to about 2.5 mm, and have a diameter of between about 1 mm and about 3 mm. Other embodiments of the capillary channel may be curved or some other shape, and/or have other dimensions.

The sorptive porous member may comprise a sintered polymeric material, a cellulosic material, an injectable porous polymeric material, a polypropylene material, a polyethylene material, a high density polyethylene material, ultra-high molecular weight polyethylene, a plurality of hydrophilic polyethylene sheath/polyester core (PE/PET) fibers, a plurality of hydrophilic polyester sheath/polyester core (PET/PET) fibers, any combination thereof or any other suitable material which is capable of matrix sorptivity. The sorptive member in some embodiments may be treated with a surfactant, to make it hydrophilic or to enhance its hydrophilicity. For example, a detergent, such as a 1 percent solution of Tween 20 in isopropanol can be used for treating the sorptive member to make it hydrophilic or enhance its hydrophilicity. A surfactant can also be added during the sintering of the raw material(s) from which the sorptive member is made to make it hydrophilic or to enhance its hydrophilicity. Such a surfactant can comprise without limitation a dry form of sodium methyl oleoyl taurate. In other embodiments, the sorptive member can be made hydrophilic or have its hydrophilicity enhanced by performing a plasma treatment during the sintering of the raw material(s) from which the sorptive member is made or after the sorptive member is made. The plasma treatment can comprise without limitation a low temperature corona discharge plasma treatment.

The shape, volume, and the percent porosity of the sorptive member can vary depending upon the liquid specimen to be sampled and analyzed. For example, some embodiments of the sorptive member can have a cylindrical shape, can have a volume between about 35 microliters and about 80 microliters, and can have a porosity between about 40% and about 60%. In other embodiments, the sorptive member can have a square shape, a rectangular shape or some other suitable shape which facilitates mounting in the device container, and/or have other volumes and/or porosities.

In some embodiments, the sorptive member can be made by molding it on an end of a pin (core pin) which is shaped and dimensioned to form the capillary channel. The sample device container can then be over-molded around the sorptive member and core pin. In other embodiments, the sorptive member can be molded and then placed on an end of a core pin (which is shaped and dimensioned to form the capillary channel) and then the sampling device container can be over-molded around the sorptive member and the core pin. In further embodiments, the sorptive member and sampling device container can be molded separately. The sorptive member can then be assembled into the sampling device container.

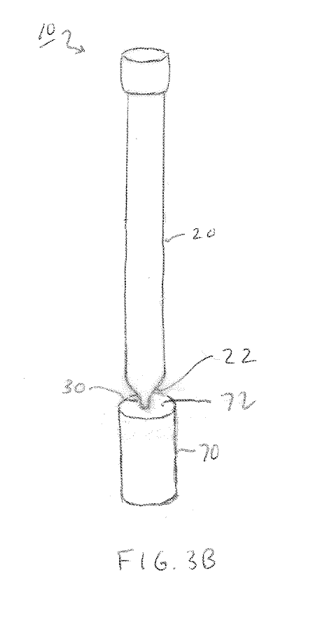

FIG. 3B illustrates an embodiment of the reagent container 70 for storing the analytical testing reagent. The reagent container 70 may comprise a conventional vial or other receptacle. The analytical testing reagent 74 to be stored in the reagent container 70 may comprise an aqueous or non-aqueous solvent, such as a buffer solution. In some embodiments, the reagent container 70 may be pre-filled with the analytical testing reagent 74 and sealed by a frangible substrate 72, such as a metal foil.

FIGS. 3A-3C depict the operation of the system according to one embodiment of the present disclosure. Starting with FIG. 3A, the extended sampling end portion 30 of the sample collecting section 22 of the sampling device 10 is brought into contact with a liquid specimen S, such as a bodily fluid to be analyzed and liquid specimen enters the inlet end 50 of the capillary channel 42. As the liquid specimen S enters the inlet end 50 of the capillary channel 42, capillary action within the channel 42 (shown with arrows in FIG. 3A) draws the specimen S into the channel 42. When liquid specimen S reaches the outlet end 52 of the capillary channel 42, capillary action within the sorptive member 44 (also shown with arrows in FIG. 3A) draws the liquid specimen S out of the capillary channel 42 and into the sorptive member 44. As the sorptive member 44 draws the liquid specimen S out of the capillary channel 42, the capillary action within the capillary channel 42 draws additional liquid specimen S into the channel 42. This process continues until the sorptive member 44 and the capillary channel 42 are both filled with a predetermined sample volume of the liquid specimen S.

As shown in FIGS. 3B and 3C, the predetermined sample volume of the liquid specimen S drawn into the capillary channel 42 and sorptive member 44 of the capillary sample collecting system can be diluted and flushed into the interior chamber 36 of the container barrel section 24 with the reagent 74 (shown with arrows in FIG. 3C) contained in the reagent container 70, by forcing the extended sampling end portion 30 of the sample collecting section 22 through the frangible substrate 72 and subsequently into the reagent container 70. The frustoconical outer surface portion 28 of the sample collecting section 22 of the container 20 allows the sample collecting section 22 to form a substantially air-tight seal with the edge 71 of the reagent container rim 71, thereby inducing a pressure that pumps the reagent 74 out of the reagent container 70 and through the capillary sample collecting system. This seal allows a controlled volume of liquid 74 reagent to be pumped from the reagent container 70 into the sample collecting system of the sampling device 10. The controlled volumes of liquid specimen and reagent form a mixture that enters the interior chamber 36 of the container barrel section 24 of the sampling device 10 where it can be analyzed the by sample analyzer 60. In the case of a test strip sample analyzer, the result of the analysis can be viewed on the test strip. The controlled volumes of the liquid specimen and reagent in the mixture allow for greater reproducibility in testing.

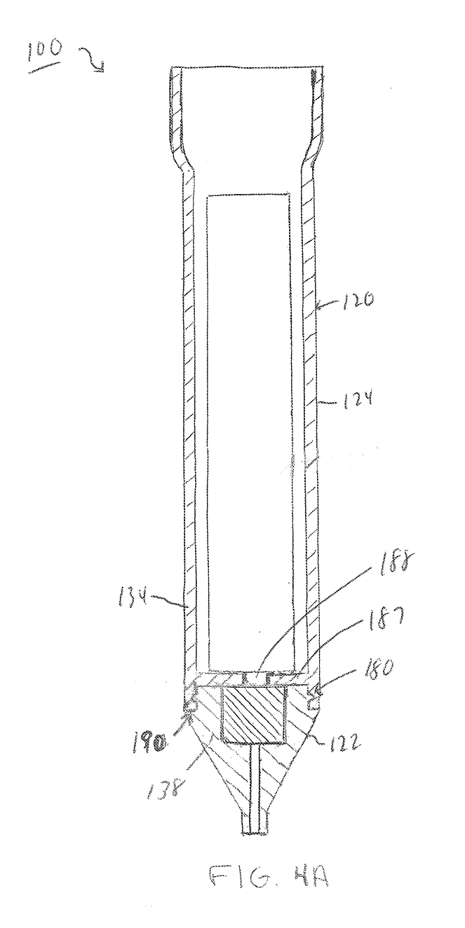

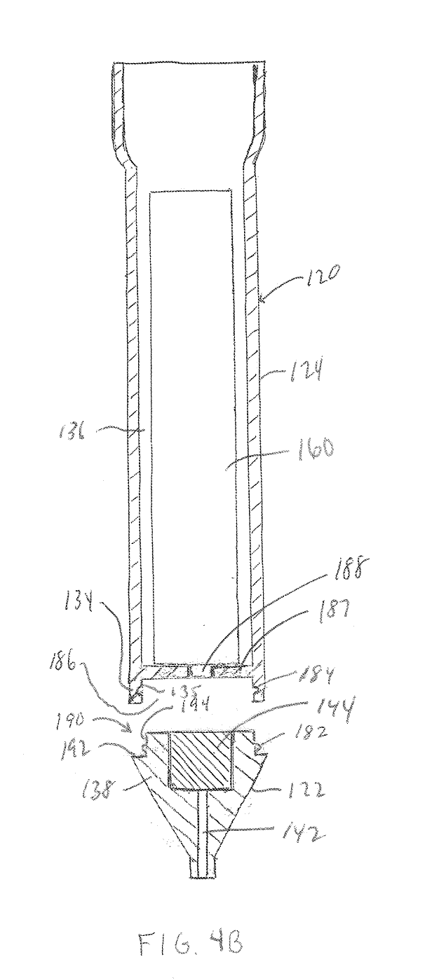

FIGS. 4A and 4B illustrate another embodiment of the sampling device 100 of the present disclosure. In this embodiment, the sample collecting and barrel sections 122 and 124, respectively, of the sampling device container 120 comprise separate members which are integrally connected to one another by a locking arrangement 180. The solid body 138 of the sample collecting section 122 can comprise a stepped connecting end 190 formed by an annular shoulder surface 192 and an annular side surface 194 that extends up from the inner periphery of the annular shoulder surface 192 (FIG. 4B). The side wall 134 of the container barrel section 124 can comprise an open connecting end 186 (FIG. 4B) which is configured to mate with the stepped connecting end 190 of the sample collecting section 122. A retaining wall 187 can be provided within the container barrel section 124 for preventing the sorptive member 144 from moving away from the capillary channel 142 when reagent is pumped there through, as described earlier. The retaining wall 187 may be recessed from the open connecting end 186 of the container barrel section 124. The retaining wall 187 can have one or more openings 188 which allow the liquid specimen and reagent mixture to enter the interior chamber 136 of the barrel section 124 to be analyzed by the sample analyzer 160.

As best seen in FIG. 4B, the locking arrangement 180 that locks the sample collecting and barrel sections 122 and 124, respectively, together can comprise a continuous or segmented rib 182 on the annular side surface 194 of the stepped connecting end 190 of the sample collecting section 122 and a corresponding continuous or segmented groove 184 formed in the inner surface 135 of the barrel section side wall 134, marginally adjacent to the open connecting end 186 thereof.

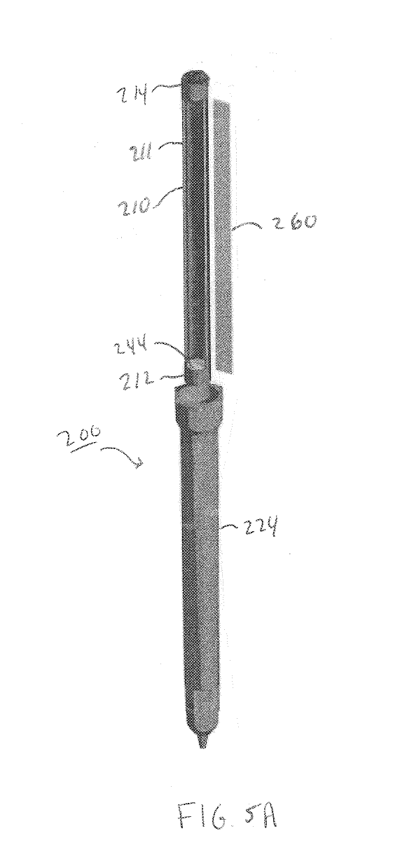

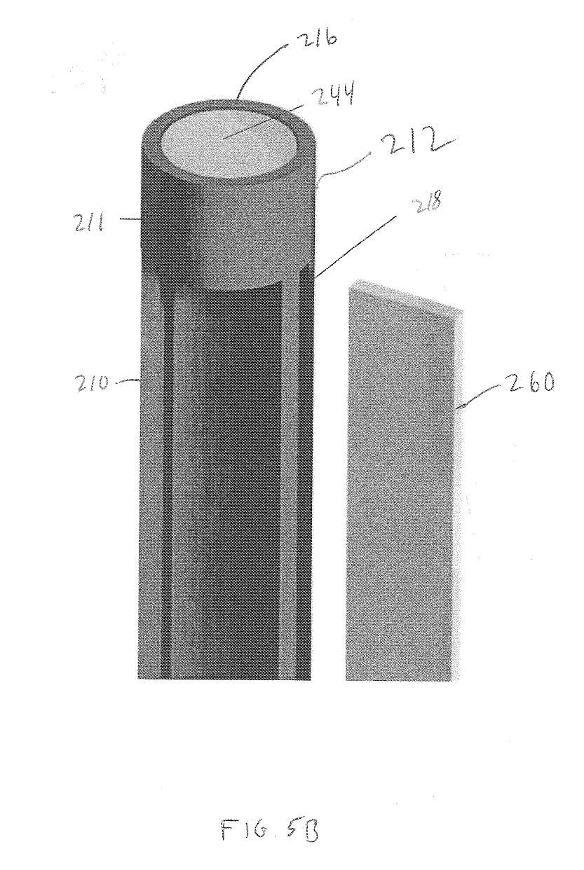

FIGS. 5A and 5B illustrate another embodiment of the sampling device 200 of the present disclosure. In this embodiment, the sampling device 200 includes a carrier 210 comprising an elongated, cylindrical side wall 211 having first and second open ends 212 and 214, respectively. The sorptive member 244 may be fixedly positioned within the carrier side wall 211 at the first end thereof 212 with the inlet surface of the sorptive member 244 disposed substantially flush with the annular rim surface 216 at the first end 212 of the carrier side wall 211. An elongated slot 218 (FIG. 5B) can be provided in the carrier side wall 211 which allows a test strip sample analyzer 260 to be inserted into the carrier 210 behind the sorptive member 244. The carrier 210 is inserted into the interior chamber of the container barrel section 224 so that the sorptive member 244 is positioned immediately adjacent to the outlet end of the capillary channel (not shown).

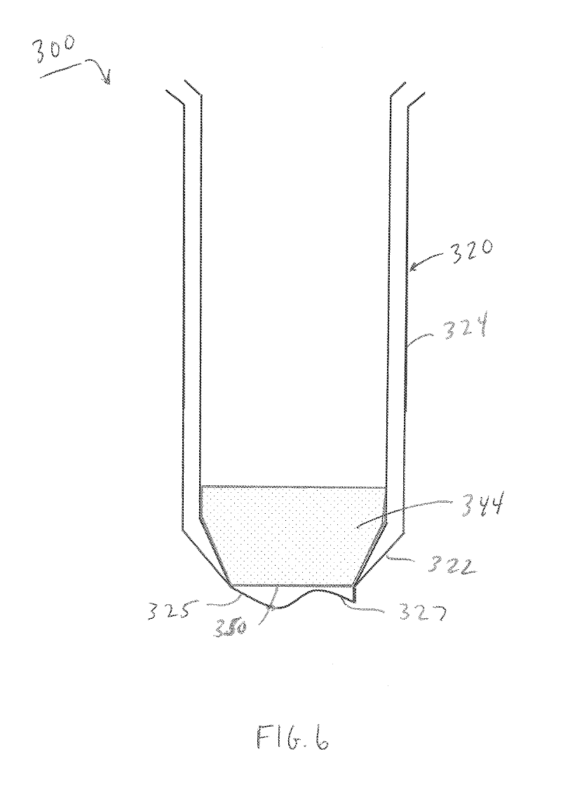

FIG. 6 illustrates another embodiment of the sampling device 300 of the present disclosure. This embodiment of the sampling device 300 omits the capillary channel of the capillary sampling system and the extended sampling end portion of the sample collecting section of the sampling container, thereby allowing direct communication of liquid specimen with the sorptive member 344 via opening 350 of the container sample collecting section 322. The container barrel section 324 of the sampling device 300 can be lengthened in this embodiment to increase the amount of reagent pumped therein due to greater displacement of the reagent in the reagent container. This enables the device 300 to be used in analyses that require more reagent to perform. A puncturing ring 325 can be provided at the opening 350 of the sample collecting section 322 for puncturing the frangible substrate sealing closing the reagent container. The free edge 327 of the puncturing ring 325 can be scalloped to facilitate puncturing of the reagent container frangible substrate.

Although the liquid specimen sampling and analyzing system, kit, and device of the disclosure have been described in terms of illustrative embodiments, they are not limited thereto. Rather, the appended claims should be construed broadly, to comprise other variants and embodiments of the system, kit, and device which may be made by those skilled in the art without departing from the scope and range of equivalents of the system, kit, and device and its elements

1. A device for sampling and analyzing a liquid specimen, the device comprising:
a sample collecting system for collecting a predetermined volume of the liquid specimen; and
a container for analyzing the liquid specimen collected by the sample collecting system;
wherein the sample collection system comprises a sorptive member.

2. The device of claim 1, wherein the sample collecting system further comprises a capillary channel having an inlet opening and an outlet opening, wherein the sorptive member is disposed at the outlet opening of the capillary channel in direct fluid communication therewith.

3. The device of claim 1, wherein the container includes a sample collecting section, and wherein the sample collecting section of the container includes the sorptive member.

4. The device of claim 3, wherein the sample collecting section of the container further includes the capillary channel of the sample collecting system.

5. The device of claim 2, wherein an outer surface of the sample collecting section has an extended portion, and wherein the capillary channel of the sample collecting system extends though the extended portion.

6. The device of claim 5, wherein the outer surface of the sample collecting section has a tapered portion.

7. The device of claim 1, further comprising a sample analyzer for analyzing the liquid specimen collected by the sample collection system, wherein the sample analyzer is disposed in the container.

8. The device of claim 7, wherein the container further includes a chamber for holding the sample analyzer.

9. The device of claim 7, wherein the sample analyzer comprises a test strip.

10. The device of claim 1, further comprising a carrier for holding the sorptive member.

11. The device of claim 10, wherein the carrier holds the sample analyzer.

12. The device of claim 10, wherein the carrier is disposed within the container.

13. The device of claim 1, wherein the carrier includes first and second ends, wherein the sorptive member is disposed at one of the first and second ends of the carrier.

14. The device of claim 1, wherein the sorptive member comprises sintered polymeric material, a cellulosic material, an injectable porous polymeric material, a polypropylene material, a polyethylene material, a high density polyethylene material, ultra-high molecular weight polyethylene, a plurality of hydrophilic polyethylene sheath/polyester core (PE/PET) fibers, a plurality of hydrophilic polyester sheath/polyester core (PET/PET) fibers, any combination thereof.

15. The device of claim 1, wherein the sorptive member has hydrophilic internal surfaces.

16. The device of claim 1, wherein the predetermined volume of the liquid specimen comprises greater than 4 microliters.

17. The device of claim 16, wherein the predetermined volume of the liquid specimen comprises up to about 80 microliters.

18. The device of claim 1, wherein the liquid specimen is collected in at least one of the capillary channel and the sorptive member.

19. The device of claim 1, wherein the liquid specimen is collected in the capillary channel and the sorptive member.

20. The device of claim 1, wherein the liquid specimen is collected in the sorptive member.

21. The device of claim 1, wherein the container is a single unitary member.

22. The device of claim 1, wherein the container further includes first and second sections connected to one another, the first section including at least one of the capillary channel and the sorptive member of the sample collecting system and the second section of the container including the chamber.

23. A system for sampling and analyzing a liquid specimen comprising a reagent container and the device of claim 1, the reagent container for containing an analytical testing reagent.

24. The system of claim 23, wherein the reagent container is pre-filled with the reagent.

25. The system of claim 24, wherein the reagent container includes an open end closed by a frangible substrate.

26. The system of claim 25, wherein the extended portion of the container of the device is for puncturing the frangible substrate.

27. The system of claim 26, wherein the tapered portion of the container of the device is for engaging the open end of the reagent container in an air-tight manner.
